(19) United States
(12) Patent Application Publication
(10) Pub. No.: US 2009/0035589 A1
(43) Pub. Date: Feb. 5, 2009

(54) Fabricating method of heterogeneous integration of aluminum alloy element and plastic element and heterogeneous integrated structure of aluminum alloy and plastic

(76) Inventor: Kun-Neng Lee, Sanchong City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,647

(22) Filed: Nov. 7, 2007

(30) Foreign Application Priority Data
Aug. 1, 2007 (TW) 096128317

(51) Int. Cl. B32B 15/04; B29C 65/70

(52) U.S. Cl. 428/457; 264/135; 264/78

(57) ABSTRACT

A fabricating method is used for fixing a plastic element to an aluminum alloy element. According to the method, an aluminum alloy forming process is performed for forming an aluminum alloy element made of aluminum. Then, an anodic layer is formed on the aluminum alloy element through an anodic treatment, such that a plurality of micro-holes is formed in the anodic layer. Finally, molten plastic are solidified on the anodic layer through a plastic insert molding. The molten plastic forming the plastic element is filled into the micro-holes of the anodic layer, so as to fix the plastic element on the aluminum alloy element.

### CROSS-REFERENCE TO RELATED APPLICATIONS

This non-provisional application claims priority under 35 U.S.C. § 119(a) on Patent Application No(s). 096128317 filed in Taiwan, R.O.C. on Aug. 1, 2007, the entire contents of which are hereby incorporated by reference.

### BACKGROUND

1. Field of Invention

The present invention relates to an integration of heterogeneous elements, and more particularly to the integration of a plastic element and an aluminum alloy element.

2. Related Art

Aluminum alloy elements have characteristics of light weight and high strength, while plastic elements have advantages of low cost and rapid manufacturing. Therefore, part of the structure components in electronic elements are made of aluminum alloy, and some of the structure components are made of plastic. It is inevitable to integrate the plastic elements with the aluminum alloy elements together. Therefore, it becomes an important issue how to effectively integrate the plastic elements on the aluminum alloy elements.

Referring to FIG. 1, an integration structure in the prior art is shown. An aluminum alloy element 1 is usually used to fabricate a housing of an electronic device to enhance the endurance of the electronic device against external shocks. However, as the aluminum alloy is electrically conductive, an insulating plastic element 2 is required to support an electronic element (e.g., a circuit board) on the aluminum alloy element 1. As the material properties of the plastic element 2 and the aluminum alloy element 1 are quite different, they cannot be directly integrated by welding, and the common method is to form buckling structures 3a, 3b corresponding to each other on the aluminum alloy element 1 and plastic element 2. According such integration manner, the corresponding buckling structures 3a, 3b must be formed on the aluminum alloy element 1 and the plastic element 2 in advance and assembled. Though the buckling structures 3a, 3b have good fixing force, they are easily damaged during the assembly.

Referring to FIG. 2, another integration manner in the prior art integrates the plastic element 2 on the aluminum alloy element 1 with an adhesive medium 4. However, the fixing force of the adhesive medium 4 is small, so the plastic element 2 may drop easily. Meanwhile, the adhesive medium 4 has a certain thickness a, which changes along with the pressure applied on the plastic element 2 during the adhering process. Therefore, in addition to the tolerance of the thickness d1 of the aluminum alloy element 1, the tolerance of the thickness a of the adhesive medium 4 should be taken into account when determining the size of the plastic element 2, such that the tolerance of the size of the plastic element 2 is difficult to determine.

Directed to the problems in prior art, a technology of directly forming the plastic element on the aluminum alloy element is set forth. For example, a composite of aluminum alloy and resin is set forth in Europe patent publication No. EP1559541, also published as China patent publication No. CN1711170. The surface of the aluminum alloy element is corroded by acid/alkali to roughen the surface of the aluminum alloy element. Then a polyphenylene sulfide-containing thermoplastic resin is integrally formed on the surface of the aluminum alloy element. Also, another composite of aluminum alloy and resin is set forth in US patent publication No. US2006/0257624, also published as China patent publication No. CN1717323. Recesses or protrusions are formed on the surface of the aluminum alloy element by fine micro-etching, and then a specific thermoplastic resin is integrally formed on the aluminum alloy element.

Both the applications, EP1559541 and US2006/0257624, improve the surface roughness of the aluminum alloy element, so as to increase the contacting area to enhance adhesion between the plastic element and the aluminum alloy element when the plastic element is integrally formed on the aluminum alloy element. Due to the difference between the material characteristics of the aluminum alloy and the plastic element, the plastic element can be made of specific thermoplastic resin only, thus limiting the material selection of the plastic element.

### SUMMARY

Accordingly, an object of the present invention is to provide a fabricating method of heterogeneous integration for fixing a plastic element onto an aluminum alloy element, so as to solve the problem that the step of fixing a plastic element on an aluminum alloy element is complex and the fixing effect is poor in the prior art.

To achieve the above object, the present invention provides a fabricating method for fixing a plastic element on a surface of an aluminum alloy element. According to the method, an aluminum alloy element made of aluminum alloy is formed with a predetermined shape by a aluminum forming process. Next, an electrochemical anodizing process is performed on the aluminum alloy element to form an anodic layer with a plurality of micro-holes on the surface of the aluminum alloy element. Finally, a plastic insert molding process is performed on the aluminum alloy element, such that molten plastic is solidified to form a plastic element on the anodic layer, and the molten plastic for forming the plastic element is also filled into the micro-holes, so as to fix the plastic element on the aluminum alloy element.

The present invention also provides a heterogeneous integrated structure of aluminum alloy and plastic, which includes an aluminum alloy element and a plastic element fixed on the aluminum alloy element. The surface of the aluminum alloy element has an anodic layer with a plurality of micro-holes. The plastic element is formed on the aluminum alloy element through a plastic insert molding process. The plastic element has an integrating surface to be fixed on the anodic layer of the aluminum alloy element. The plastic element further has a plurality of extending portions, which are integrated into each micro-hole in the plastic insert molding process. By integrating the extending portions into the micro-holes, the plastic element is firmly fixed on the aluminum alloy element.

The advantage of the present invention is that the plastic element is directly formed on the aluminum alloy element directly and is fixed on the aluminum alloy element through the micro-holes, thus simplifying the steps for fixing the plastic element on the aluminum alloy element. Meanwhile, such integration allows the plastic element to be capable of resisting external forces from various directions, and the fixing force is superior to that of the prior art.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a cross-sectional view of fixing a plastic element on a aluminum alloy element by a latching structure in the prior art;

FIG. 2 is a cross-sectional view of fixing a plastic element on a aluminum alloy element by an adhesive in the prior art;

FIG. 3A is a cross-sectional view of a heterogeneous integrated structure of aluminum alloy and plastic according to a first embodiment of the present invention;

FIGS. 3B and 3C are enlarged cross-sectional views of the integration site of the plastic element and the aluminum alloy element in FIG. 3A;

FIG. 4 is a partial cross-sectional view of the heterogeneous integrated structure of aluminum alloy and plastic according to the first embodiment;

FIGS. 5A and 5B are top views of a heterogeneous integrated structure of aluminum alloy and plastic according to a second embodiment of the present invention;

FIG. 5C is a partial cross-sectional view of the heterogeneous integrated structure of aluminum alloy and plastic according to the second embodiment;

FIG. 6 is a flow chart of a fabricating method for fixing a plastic element on an aluminum alloy element and a plastic element of the present invention;

FIGS. 7 and 8 are flow chart of an electrochemical anodizing process;

FIG. 9 is schematic view of placing the aluminum alloy element and a metal sheet in an electrolyte during the electrochemical anodizing process;

FIG. 10 is a cross-sectional view of forming an anodic layer by adhering aluminum hydroxide on the surface of the aluminum alloy element;

FIGS. 11A, 11B, 11C, and 11D are schematic views of the anodic layer growing and changing with the time;

FIG. 12 is a cross-sectional view of placing the aluminum alloy element inside a mold to perform a plastic insert molding process; and

FIGS. 13A, 13B, and 13C are partial cross-sectional views of filling molten plastic into the micro-holes of the anodic layer.

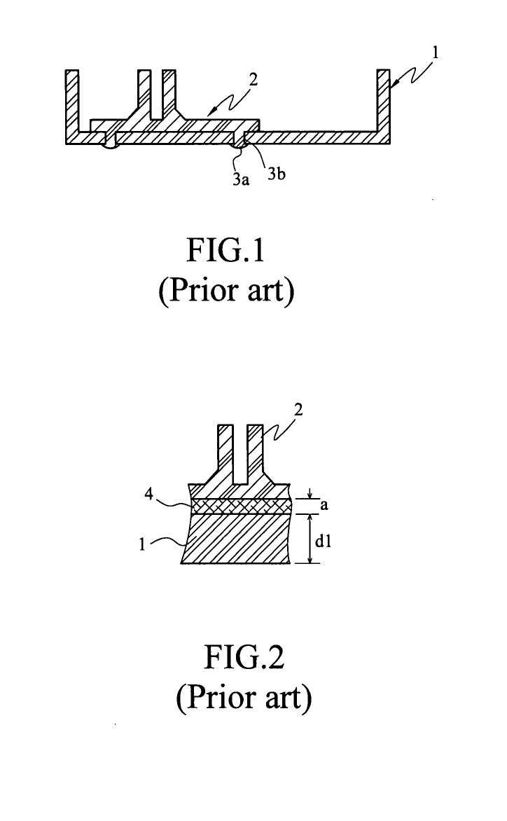

### DETAILED DESCRIPTION OF THE INVENTION

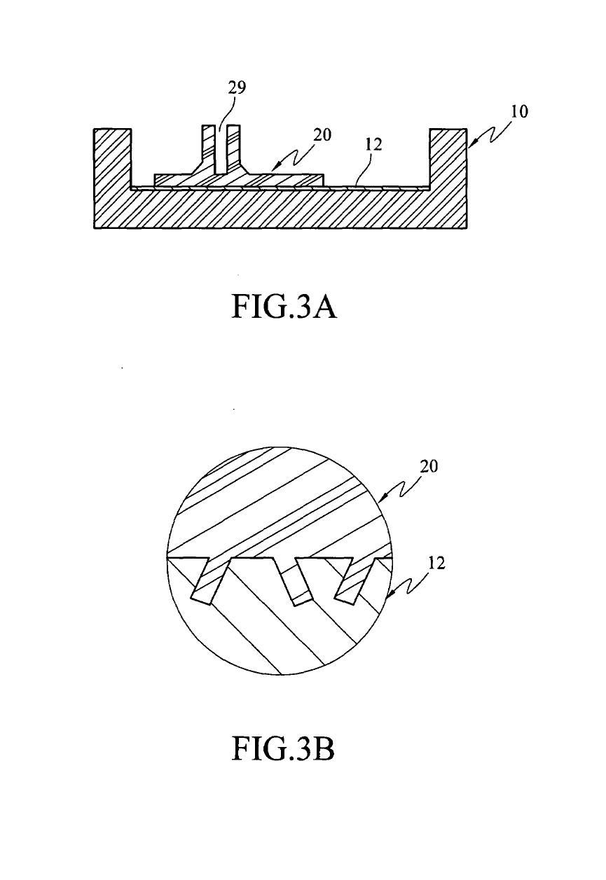

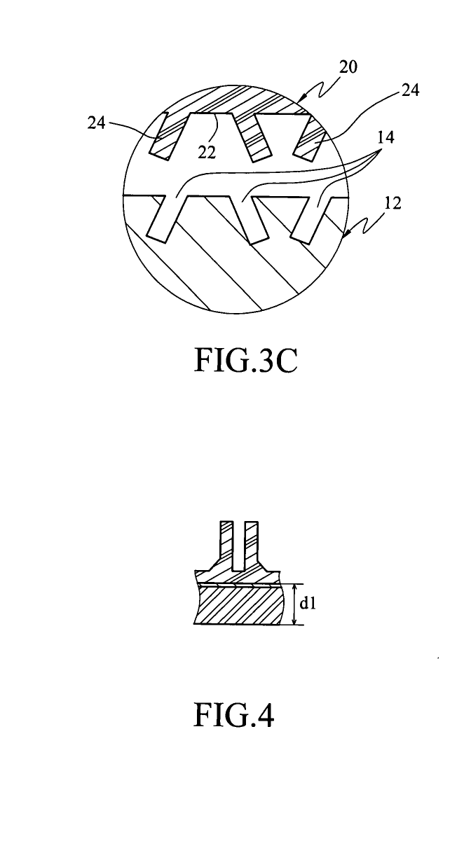

Referring to FIGS. 3A, 3B, and 3C, a heterogeneous integrated structure of aluminum alloy and plastic according to a first embodiment of the present invention is shown. The heterogeneous integrated structure includes an aluminum alloy element 10 and a plastic element 20 integrated with the aluminum alloy element 10. The aluminum alloy element 10 can be housing or internal structure component of an electronic device. The plastic element 20 can be a connecting member for connecting different structural components. In this embodiment, for example, the aluminum alloy element 10 is a part of the housing of an electronic device, and the plastic element 20 is a fixing pillar fixed on the inner surface of the aluminum alloy element 10 and has a screw hole 29 for a screw to be fastened to fix another element on the aluminum alloy element 10. The aluminum alloy element 10 has an anodic layer 12 formed on a surface of the aluminum alloy element 10, and the anodic layer 12 has a plurality of micro-holes 14 formed therein. The plastic element 20 is directly formed on the aluminum alloy element 10 by means of plastic insert molding process, and the plastic element 20 has an integrating surface 22. The plastic element 20 is integrated on the anodic layer 12 of the aluminum alloy element 10 with the integrating surface 22. The plastic element 20 further has a plurality of extending portions 24 integrated into each micro-hole 14. Different oblique angles are formed between the normal directions of the micro-holes 14 and each aluminum alloy element 20, and the extending portions 24 corresponding to each micro-hole 14 are formed along the micro-holes 14, so as to provide integration forces in various directions.

Referring to FIG. 4, in the first embodiment, as the adhesive is not required between the aluminum alloy element 10 and the plastic element 20, and the anodic layer 12 is directly converted from a chemical reaction of the aluminum atoms on the surface of the aluminum alloy element 10, the thickness d1 of the aluminum alloy element 10 will not be increased additionally by adhesive. The anodic layer 12 is an aluminum oxide layer including aluminum oxide and aluminum oxide hydrates, and the aluminum alloy element 10 further contains dye molecules, which directly permeate into the anodic layer 12, so the aluminum alloy element 10 exhibits a predetermined color.

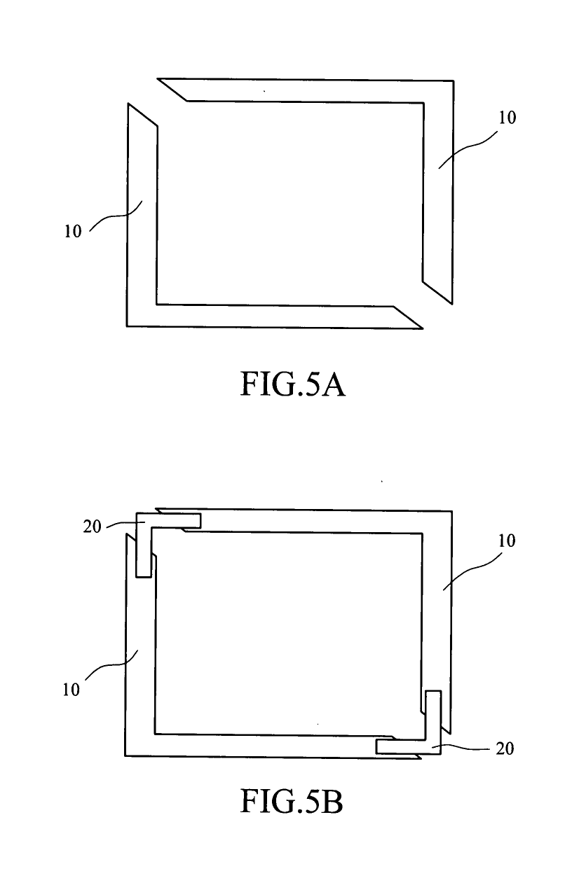

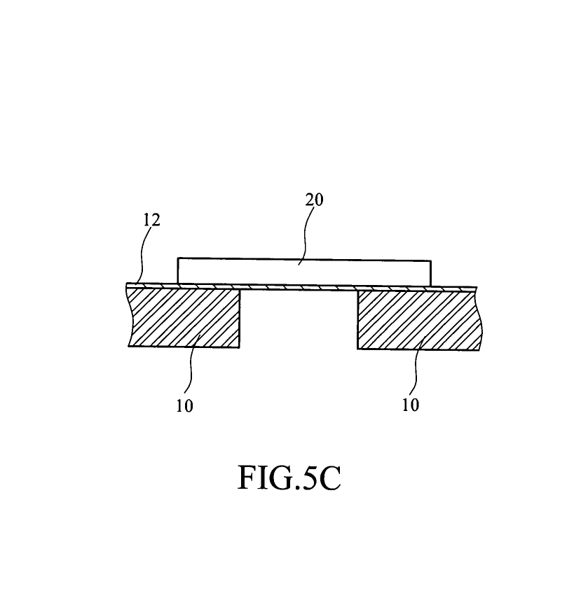

Referring to FIGS. 5A, 5B, and 5C, a heterogeneous integrated structure of aluminum alloy and plastic according to a second embodiment of the present invention is shown. The second embodiment includes two aluminum alloy elements 10 and two plastic elements 20 that form a front frame of a display. The two aluminum alloy elements 10 are in an L-shape, and have two ends connected by the plastic elements 20, and thus the two aluminum alloy elements 10 are integrated together to form the front frame. The integration manner of the aluminum alloy elements 10 and the plastic element 20 is the same as that of the first embodiment. The plastic element 20 is integrated with the anodic layer 12 of the surface of the aluminum alloy element 10, and no additional adhesive or additional latching structure is required for fixing the plastic element 20 on the aluminum alloy element 10. By changing the size of the plastic elements 20, the size of the front frame of the display is also changed.

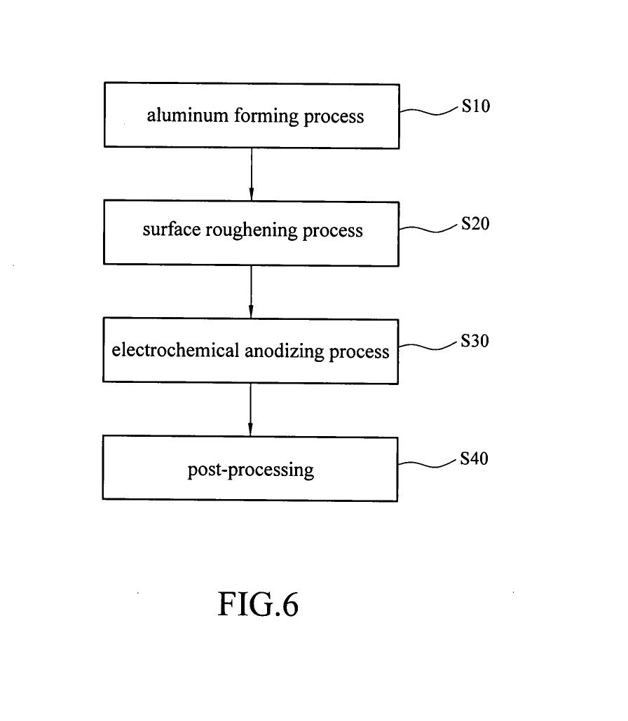

Referring to FIG. 6, a fabricating method for fixing a plastic element on an aluminum alloy element of the present invention is shown. According to the method, the latching structure or an adhesive is not required between the aluminum alloy element 10 and the plastic element 20.

Referring to FIG. 6, according to this method, an aluminum forming process S10 is perform at first for forming an aluminum alloy element, for example, the aluminum alloy can be formed by machining, molding, stamping, or die casting, in the aluminum forming process S10 with the aluminum alloy as raw material is processed to form the aluminum alloy element 10 with a predetermined shape required. Generally speaking, in order to save cost and improve the yield, the aluminum alloy element 10 mostly uses aluminum alloy ingots as raw material, which is heated to be molten into liquid aluminum alloy, and then is injected into a mold 43 by a die casting machine, so as to be molded into the predetermined shape, for example, a housing of an electronic product.

After the aluminum alloy element 10 is formed through the aluminum forming process S10, a surface roughening process S20 is performed on the aluminum alloy element 10 to improve the surface roughness of the aluminum alloy element 10 and remove the oxidyum on the surface of the aluminum alloy element 10, thereby improving the efficiency of the subsequent surface treatment on the aluminum alloy element 10. The surface roughening process S20 may be sandblasting, metal wiredrawing, or metal micro-etching on the surface.

Referring to FIG. 6, an electrochemical anodizing process S30 is performed on the aluminum alloy element 10. During the electrochemical anodizing process S30, a plastic insert molding process S35 is performed on the aluminum alloy element 10 to make the plastic element 20 formed on the surface of the aluminum alloy element 10, so as to integrate the plastic element 20 on the aluminum alloy element 10. The electrochemical anodizing process S30 includes a degreasing and cleaning step S31, an oxide layer-removing step S32, a neutralization step S33, an anodizing step S34, a plastic insert molding process S35, and a sealing step S36.

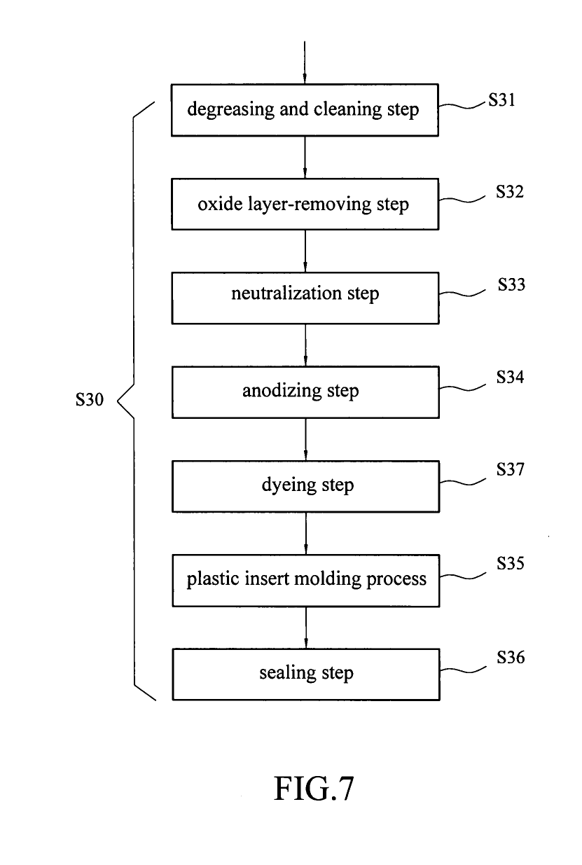

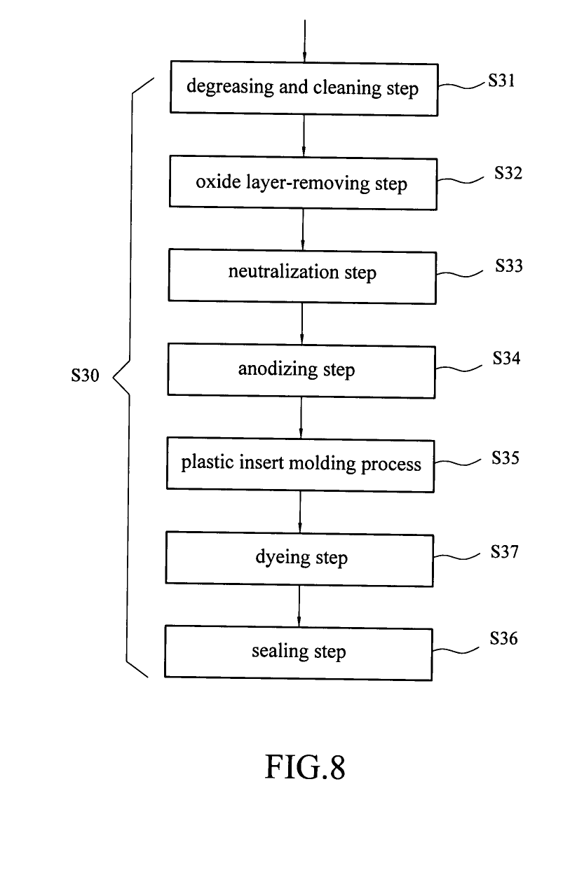

Referring to FIGS. 7 and 8, after the aluminum alloy element 10 is formed in the aluminum alloy forming process S10, impurities such as greases and dirt are often retained on the surface of the aluminum alloy element 10. Since the impurities dispersed on the surface of the aluminum alloy element 10 will negatively affect the surface characteristics of the aluminum alloy element 10, the anodizing effect of on the surface is negatively affected. Therefore, before the electrochemical anodizing process S30, the degreasing and cleaning step S31 is performed on the aluminum alloy element 10 to remove the greases and dirt on the surface of the aluminum alloy element 10. In degreasing and cleaning step S31, a detergent, for example, petrochemical detergent, hydrochloric ether detergent, alkali detergent, or surface active agent containing detergent, is used to clean the aluminum alloy element 10, so as to effectively dissolve the greases and make the dirt peel off. And then, the aluminum alloy element 10 goes through a water washing step to remove the grease, dirt, and detergent residue.

Referring to FIGS. 7 and 8, then an oxide layer-removing step S32 is performed on the aluminum alloy element 10 to remove oxide layers on the surface of the aluminum alloy element 10. The aluminum alloy is easily oxidized, so after the aluminum alloy element 10 is formed, the surface gradually becomes the oxide layer (aluminum oxide and aluminum oxide hydrates). Though the oxide layer has inactivation characteristic and can protect the aluminum alloy element 10 from the damages caused by environmental factors, the oxide layers can not satisfy our requirement, so the oxide layers must be removed. In the oxide layer-removing step S32, an alkali liquor is used to corrode the surface of the aluminum alloy element 10 to decompose aluminum oxide (aluminum oxide and its hydrates), so as to be removed with the alkali liquor. As the aluminum alloy element 10 is cleaned and corroded with the alkali liquor, this step is also called as alkali washing step. Similarly, after the oxide layer-removing step S32, a water washing step is performed to remove the alkali liquor and the alkaline corrosion product (powder) from the aluminum alloy element 10.

Referring to FIGS. 7 and 8, although the aluminum alloy element 10 has been subjected to a water washing step after the oxide layer-removing step S32, the alkali liquor is still remained on the surface of the aluminum alloy element 10, and alkaline corrosion product with alkali base are closely attached on the surface of the aluminum alloy element 10.

Referring to FIGS. 7 and 8, directed to the above problems, a neutralization step S33 is performed on the aluminum alloy element 10 to neutralize the alkali liquor residue on the surface of the aluminum alloy element 10 to remove the alkaline corrosion product. During the neutralization step S33, acid liquor, such as, nitric acid or phosphoric acid solution is used to clean the surface of the aluminum alloy element 10 to neutralize the alkali liquor and discompose the alkaline corrosion product, so the neutralization step S33 is also called as an acid washing step. Similarly, after the neutralization step S33, a water washing step is performed to remove the acid liquor and other impurity residues from the aluminum alloy element 10.

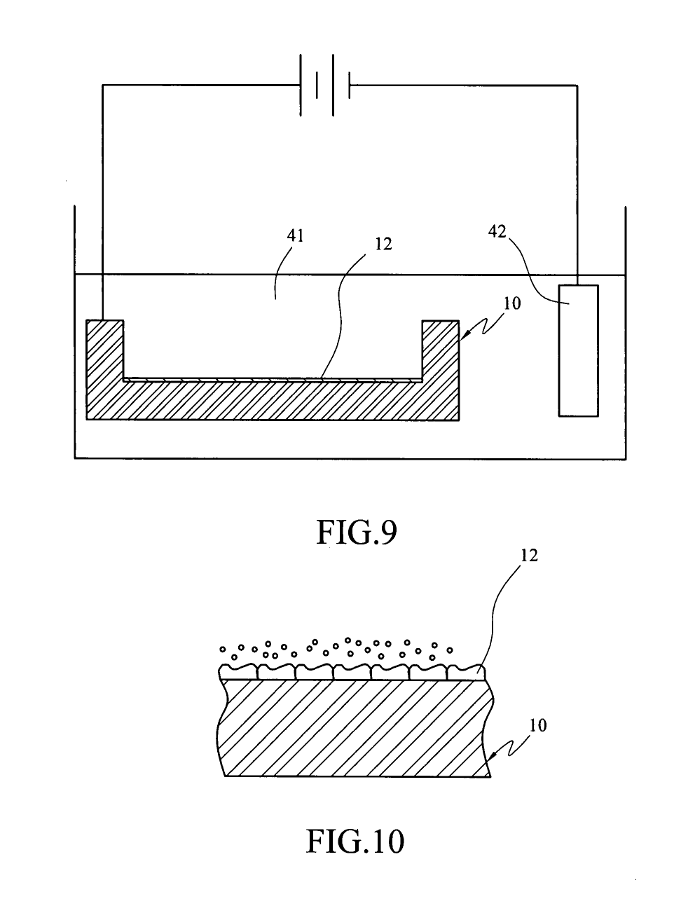

Referring to FIGS. 7, 8, and 9, then an anodizing step S34 is performed on the aluminum alloy element 10 to form micro-holes 14 in the surface of the aluminum alloy element 10. The anodizing step S34 is an electrolysis process. In the anodizing step S34, the aluminum alloy element 10 is placed in an electrolyte 41 as an anode while the electrolyte 41 serves as cathode. At the same time, a metal sheet 42 is placed in the electrolyte, and two ends of a DC power supply are electrically connected to the aluminum alloy element 10 and the metal sheet 42. The material of the metal sheet 42 is pure aluminum or an aluminum alloy to provide aluminum into the electrolyte 41. The electrolyte 41 may be an acidic solution, for example, sulfuric acid, boric acid, oxalic acid, chromic acid, phosphoric acid, sulfonated organic acid, etc. that is capable of ionizing the metal sheet 42 or aluminum atoms of the aluminum alloy element 10. All the foregoing acidic solutions have their operation conditions, such as, concentration, temperature, electrical current flux, and applied voltage, and the optimal operation conditions of each acidic solution can be found through a practical experiment of the anodizing step S34.

During the anodizing step S34, many kinds of chemical reactions take place simultaneously in the electrolyte 41. The main mechanism is to provide electrical power on the metal sheet 42 to make the metal on the metal sheet 42 become ions free in the electrolyte 41, such that the electrolyte 41 becomes a solution of aluminum ions (ionization reaction). At the same time, the aluminum oxide layer (Al₂O₃) that originally forms the surface of the aluminum alloy element 10 and dose not meet the requirements may be dissolved and dissociated into aluminum ions and water under the effect of hydrogen ions (dissolution reaction). The aluminum ions react with OH⁻ in the electrolyte 41 to form aluminum hydroxide, and be attached on the surface of the aluminum alloy element 10 (chemical reaction). During the anodizing step S34, the aluminum hydroxide is gradually decomposed into aluminum oxide hydrates (aging procedure). However, due to the equilibrium of chemical reaction, during the anodizing step S34, the aluminum hydroxide attached on the surface of the aluminum alloy element 10 does not be totally discomposed into aluminum oxide hydrate, and aluminum hydroxide will be gradually converted into alumina (aluminum oxide layer) after the aluminum alloy element 10 is exposed to air. The foregoing chemical reactions are expressed by the following formulas.

Ionization reaction: Al→Al³⁺+3e⁻

Chemical reaction: Al³⁺+3OH⁻→Al(OH)₃

Dissolution reaction: Al₂O₃+6H⁺→2Al³⁺+3H₂O

Aging procedure: Al(OH)₃>Al₂O₃.H₂O+2H⁺+2OH⁻

Referring to FIG. 10, during the process that aluminum hydroxide is attached on the surface of the aluminum alloy element 10, the film is not formed with uniform thickness, but a porous and viscous anodic layer 12 (aluminum hydroxide film) is formed.

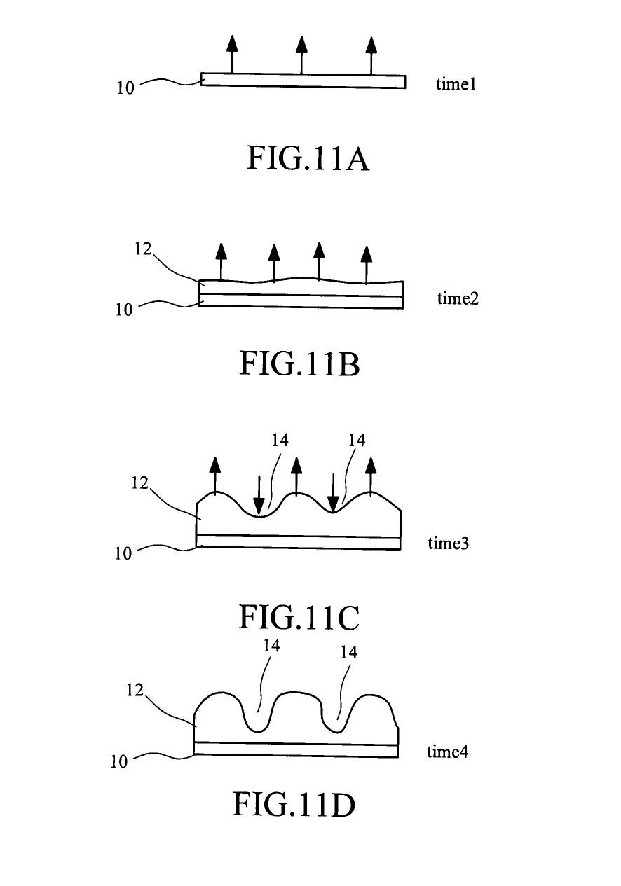

Referring to FIGS. 11A, 11B, 11C, and 11D, micro-holes 14 extending towards the surface of the aluminum alloy element 10 are formed on the surface of the anodic layer 12, and the process of forming the structural form of the micro-holes 14 is illustrated as follows. Referring to FIG. 11A, when starting to supply electrical power for performing the anodizing step S34, the original aluminum oxide layer on the surface of the aluminum alloy element 10 begins to be dissolved (time 1), and a part of the aluminum may also be dissolved. Referring to FIG. 11B, the amount of dissolved aluminum on the surface of the aluminum alloy element 10 grows with the increasing of time. At the same time, the surface of the aluminum alloy element 10 becomes rough due to the anodic layer 12 (time 2). Referring to FIG. 11C, as the ragged anodic layer 12 on the surface of the aluminum alloy element 10 results in diverse dissolution rates, the part that is dissolved faster is gradually depressed to form micro-holes 14 (time 3). Meanwhile, the dissolved aluminum ions are gradually converted into aluminum hydroxide and aluminum oxide deposited on the surface, and some cavities are still left for continuously performing dissolution. After a long period of time, the micro-holes 14 are formed on the anodic layer 12 that formed by the deposition of aluminum hydroxide (time 4). The main component of the wall of the micro-holes 14 is aqueous aluminum oxide or colloidal aluminum hydroxide. The water content is gradually reduced and the aluminum oxide becomes purer from the edge to the center of the wall. The area near the electrolyte 41 is the area where aluminum is dissolved and deposited. The area is more compact as the deposition lasts longer. The bore diameter of the micro-holes 14 is in positive relation with the operating voltage of the anodizing process. The higher the applied voltage of the electrical power is, the larger the bore diameter will be.

After the anodizing step S34, an anodic layer 12 (containing aluminum hydroxide, aluminum oxide, aluminum oxide hydrates) with a plurality of micro-holes 14 formed on the surface of the aluminum alloy element 10, and the micro-holes 14 are densely distributed on the anodic layer 12 uniformly. Although the anodic layer 12 undergoes chemical reaction (aluminum hydroxide is aged into aluminum oxide) when exposed to the air, the structure of the micro-holes 14 can still be maintained, and the micro-holes 14 may be filled with liquid-state material.

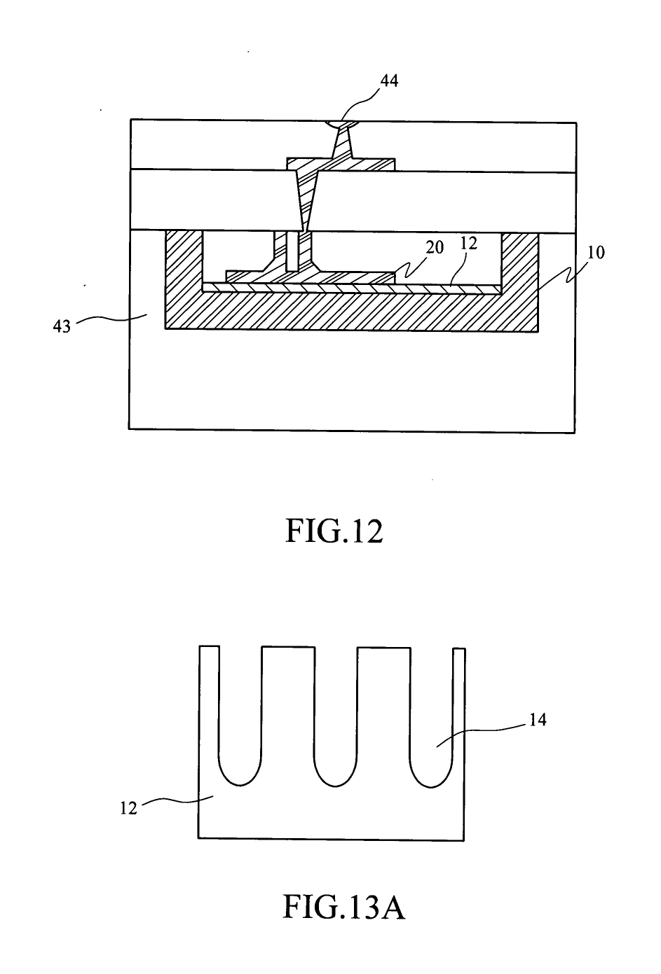

Referring to FIGS. 7, 8, and 12, a plastic insert molding process S35 is performed on the aluminum alloy element 10 to form the plastic element 20 on the anodic layer 12 of the aluminum alloy element, and the molten plastic 20a for forming the plastic element 20 is filled into the micro-holes 14 of the anodic layer 12. During the plastic insert molding process S35, the aluminum alloy element 10 is placed in the mold 43, and the part of the surface of the aluminum alloy element 10 for the plastic element 20 to be fixed thereon is made to face a mold chamber of the mold 43. Then the high-temperature liquid-state molten plastic 20a is injected through a sprue 44 of the mold 43 to fill the molten plastic 20a into the mold chamber.

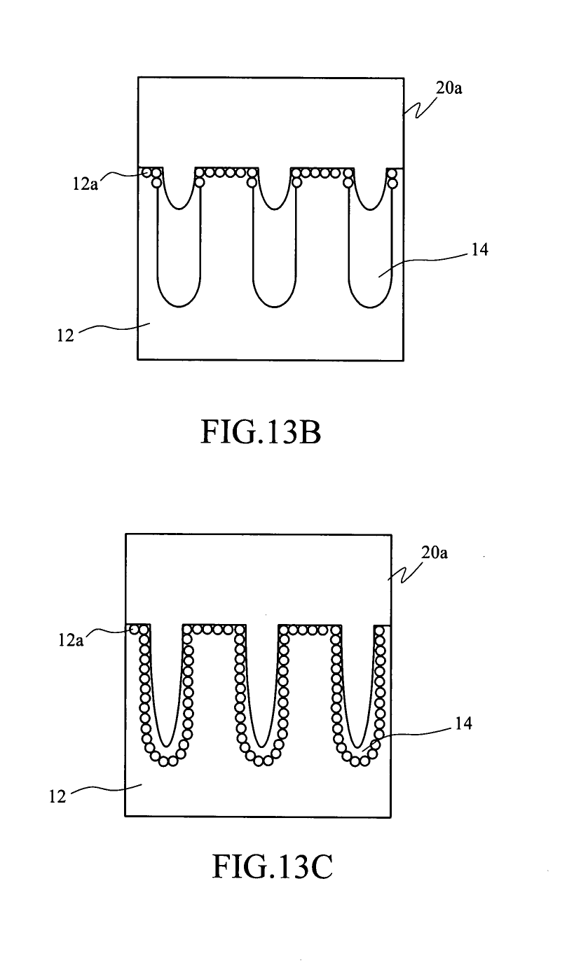

Referring to FIGS. 13A, 13B, and 13C, when the molten plastic 20a contacts the anodic layer 12 of the aluminum alloy element 10, the molten plastic 20a is filled into the micro-holes 14 and the temperature of the molten plastic is reduced rapidly, so that the molten plastic 20a is solidified to form the plastic element 20. The aluminum hydroxide of the walls of the micro-holes 14 is crystallized and aged rapidly at high temperature to form a stable aluminum oxide crystal 12a. As the coefficient of thermal expansion of the aluminum alloy is much higher than that of the plastic, after the temperature of the molten plastic is reduced and the molten plastic is solidified, the shrinkage ratio of the aluminum alloy element 10 is higher than that of the plastic element 20, thus further enhancing the integration effect.

Referring to FIGS. 7 and 8, the dyeing step S37 is performed on the aluminum alloy element 10 to make the surface of the aluminum alloy element 10 have a predetermined color. The dyeing method, mainly including electrolytic procedure, organic dyes, inorganic pigments, electrolytically deposited metal, or the like, makes the dye molecules permeate into the anodic layer 12, such that the aluminum alloy element 10 directly represents a predetermined color. Based on the situation that the dye molecules permeate into the anodic layer 12, the dyed aluminum alloy element 10 may still exhibit a metallic luster that cannot be achieved by spray painting or dyeing on the aluminum alloy element 10. The dyeing step S37 is not required to be performed after the plastic insert molding process S35 (as shown in FIG. 7). As the dyeing step S37 is mainly directed to make the dye molecules permeate into the anodic layer 12, the structure of the micro-holes 14 of the anodic layer 12 will not change greatly. Therefore, the dyeing step S37 may be performed after the anodizing step S34.

After the anodizing step S34, a sealing step S36 is necessarily to be performed on the aluminum alloy element 10 to seal the micro-holes 14 of the anodic layer 12. As the micro-holes 14 are densely distributed on the surface of the anodic layer 12, the anodic layer 12 is adsorptive, which will adversely affect the surface of the aluminum alloy element 10. Meanwhile, the micro-holes 14 make the surface of the aluminum alloy element 10 to lose luster. During the sealing step S36, the aluminum alloy element 10 is placed in the boiling water and immersed for a period of time. After the high temperature processing, alumina or aluminum oxide hydrates are gradually converted and recrystallized, so the micro-holes 14 are completely filled and sealed, and the anodic layer 12 becomes to a very dense film layer. Since during the sealing step S36, the micro-holes 14 is filled and sealed, the surface of the aluminum alloy element 10 begins to exhibit metallic luster. Therefore, the sealing step S36 is also called as a coloring step.

Finally, a post-processing S40 such as a further processing step, for example, laser engraving, screen printing, or hot laminating is performed on the aluminum alloy element 10 with the plastic element 20 fixed thereon.

After the above processes and steps, the plastic element 20 can be stably integrated on the aluminum alloy element 10 without using an adhesive, a screw, or a buckling structure. Such integration manner simplifies the structure of the aluminum alloy element 10 and plastic element 20 and enhances the integration strength at the same time.

What is claimed is:

1. A fabricating method for fixing a plastic element on to an aluminum alloy element, comprising:
forming the aluminum alloy element made of aluminum alloy through an forming process;
forming an anodic layer having a plurality of micro-holes on the surface of the aluminum alloy element through an electrochemical anodizing process; and
forming the plastic element on the aluminum alloy element through a plastic insert molding, wherein molten plastic is solidified on the surface of the anodic layer to form the plastic element and filled into the micro-holes.

2. The fabricating method as claimed in claim 1, after forming the aluminum alloy element, further comprising a surface roughening process for improving the roughness of the surface of the aluminum alloy element and removing oxydum on the surface of the aluminum alloy element.

3. The fabricating method as claimed in claim 2, wherein the surface roughening process is sand blasting, metal wiredrawing, or metal micro-etching.

4. The fabricating method as claimed in claim 1, further comprising a degreasing and cleaning step for removing grease and dirt on the surface of the aluminum alloy element after the step of forming the aluminum alloy element.

5. The fabricating method as claimed in claim 1, further comprising an oxydum layer-removing step for removing oxydum on the surface of the aluminum alloy element after the step of forming the aluminum alloy element.

6. The fabricating method as claimed in claim 5, wherein the oxydum layer-removing step comprises corroding the surface of the aluminum alloy element with an alkali liquor.

7. The fabricating method as claimed in claim 6, further comprising a neutralization step for neutralizing the alkali liquor remained on the surface of the aluminum alloy element with an acid liquor and removing the alkaline corrosion product on the surface of the aluminum alloy element after the oxydum layer-removing step.

8. The fabricating method as claimed in claim 1, wherein the electrochemical anodizing process comprises:
placing the aluminum alloy element into electrolyte as an anode, and placing a metal sheet providing aluminum into the electrolyte; and
supplying electric power to the aluminum alloy element and the metal sheet to form the anodic layer with the micro-holes on the surface of the aluminum alloy element.

9. The fabricating method as claimed in claim 1, wherein the plastic insert molding comprises:
placing the aluminum alloy element into a mold, and making the part of the surface of the aluminum alloy element for the plastic element to be fixed thereon facing a mold chamber of the mold; and
injecting liquid-state molten plastic into the mold chamber, wherein the plastic liquor further enters the micro-holes, and is rapidly solidified to form the plastic element.

10. The fabricating method as claimed in claim 1, further comprising a dyeing process to make the dye molecules permeate into the anodic layer.

11. The fabricating method as claimed in claim 1, after the plastic insert molding process, further comprising a sealing step to seal the micro-holes in the anodic layer.

12. The fabricating method as claimed in claim 11, wherein the sealing step comprises immersing the aluminum alloy element in boiling water.

13. A heterogeneous integrated structure of aluminum alloy and plastic, comprising:
an aluminum alloy element, having an anodic layer with a plurality of micro-holes on the surface thereof; and
a plastic element, having a integrating surface integrated with the anodic layer of the aluminum alloy element, and the plastic element further comprising a plurality of extending portions respectively integrated into each micro-hole.

14. The heterogeneous integrated structure of aluminum alloy and plastic as claimed in claim 13, wherein the anodic layer comprises aluminum oxide, and aluminum oxide hydrates.

15. The heterogeneous integrated structure of aluminum alloy and plastic as claimed in claim 13, further comprising dye molecules permeating into the anodic layer.
